(19) United States
(12) Patent Application Publication
(10) Pub. No.: US 2025/0348259 A1
(43) Pub. Date: Nov. 13, 2025

(54) IMAGE PROCESSING APPARATUS, AND CONTROLLING METHOD OF IMAGE PROCESSING APPARATUS

(71) Applicant: CANON KABUSHIKI KAISHA, Tokyo (JP)

(72) Inventor: KYOHEI KIKUTA, Tokyo (JP)

(21) Appl. No.: 19/200,966

(22) Filed: May 7, 2025

(30) Foreign Application Priority Data
May 13, 2024 (JP) 2024-077795

(51) Int. Cl. G06F 3/12; H04N 1/00

(52) U.S. Cl. CPC G06F 3/1274; G06F 3/1203; G06F 3/1267; H04N 1/00029; H04N 1/00045; H04N 1/0009

(57) ABSTRACT

An image processing apparatus analyzes an inputted printing job of a printed product, applies information indicating a possibility of reusing the printing job to the printing job, and performs control such that the printing job to which the information is applied is continuously saved into a saving unit even after execution of printing by the printing job. In the controlling, out of the printing jobs saved in the saving unit, the printing job that is determined based on the information is deleted.

### BACKGROUND

### Field

The present disclosure relates to a technique of managing a printing job.

### Description of the Related Art

Conventionally, in the printing industry, an inspection (product inspection) operation is performed to guarantee that a product (a printed product) that is to be delivered to an orderer has no defect and has no problem with the quality thereof. In addition, there has been widely used a printing system with an in-line type automatic inspection function that performs the inspection operation sequentially after printing processing. Additionally, inspection methods include a method called scanning product inspection.

The scanning product inspection is a method in which image data obtained by reading a printed product with no defect by a scanner is used as image data (reference image data) as an inspection reference.

In this regard, in case that an additional order and the like of the same printed product is expected, an executed printing job may be saved in the printing system without being discarded after the execution. In this case, as for a printing job that performs the scanning product inspection, which is time-consuming due to generation of the reference image data, the reference image data may be additionally saved with the executed printing job. In the scanning product inspection, as the number of the saved printing jobs (and the reference image data) is increased, the free space of a storage device included in the printing system is occupied. In this regard, Japanese Patent Laid-Open No. 2022-184992 discloses a technique of automatically deleting the reference image data for the scanning product inspection saved in the storage device under certain conditions.

### SUMMARY

The image processing apparatus according to an aspect of the present disclosure includes: analyzing an inputted printing job of a printed product and applying information indicating a possibility of reusing the printing job to the printing job; and performing control such that the printing job to which the information is applied is continuously saved into a saving unit even after execution of printing by the printing job, in which, in the controlling, out of the printing jobs saved in the saving unit, the printing job that is determined based on the information is deleted.

Further features of the present disclosure will become apparent from the following description of exemplary embodiments with reference to the attached drawings.

### BRIEF DESCRIPTION OF THE DRAWINGS

FIG. 1 is a diagram illustrating an overall configuration example of a printing system;

FIG. 2 is a diagram illustrating a hardware configuration example of an image processing apparatus;

FIG. 3 is a diagram illustrating a hardware configuration example of an image formation apparatus, an inspection apparatus, and a post-processing apparatus;

FIG. 4 is a diagram illustrating a functional block example of the printing system;

FIG. 5 is a flowchart illustrating a flow of an operation of a printing processing system based on a new job;

FIG. 6 is a flowchart illustrating a detailed flow of storage control information application processing;

FIGS. 7A and 7B are diagrams illustrating a data configuration example of a printing job;

FIG. 8 is a diagram illustrating a tabulated list of saved jobs;

FIG. 9 is a diagram illustrating an inspection report example; and

FIG. 10 is a flowchart illustrating a flow of an operation of the printing processing system based on the saved job.

### DESCRIPTION OF THE EMBODIMENTS

In the above-described technique in Japanese Patent Laid-Open No. 2022-184992, the data saved in the storage device is deleted without exception in a case where a certain condition is satisfied. Therefore, data that a user does not intend to delete could be deleted.

Hereinafter, embodiments of the technique of the present disclosure are described with reference to the drawings. Note that, the following embodiments are not intended to limit the technique of the present disclosure according to the scope of claims. Not all the combinations of characteristics described in the embodiments are necessarily required as the means for solving the problems of the technique of the present disclosure, and the multiple characteristics may be combined to each other arbitrarily. The same configurations are denoted by the same reference numerals to be described. Additionally, each step in a flowchart is described with “S” provided at the beginning.

### Embodiment 1

### (Configuration of Overall System)

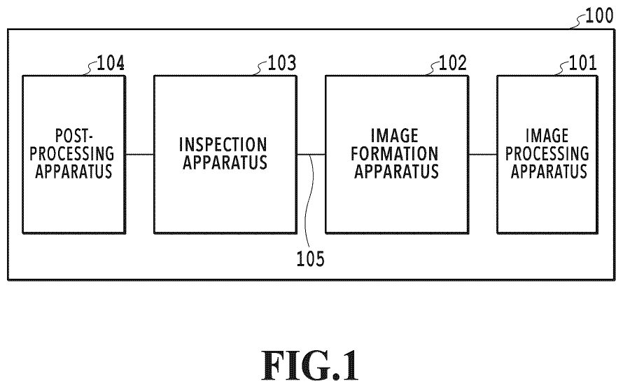

FIG. 1 is a diagram illustrating an overall configuration example of a printing system 100 according to the present embodiment. The printing system 100 includes an image processing apparatus 101, an image formation apparatus 102, an inspection apparatus 103, and a post-processing apparatus 104. The apparatuses are connected to each other via a communication cable 105 so as to be able to transmit and receive data.

A role of each apparatus to implement a function of the printing system is simply described. The image processing apparatus 101 is also referred to as a digital front end (DFE) and has a role as a printer server. That is, the image processing apparatus 101 performs RIP processing to bitmap PDL data included in an inputted printing job and generates image data (printing data) in a raster format that is used by the image formation apparatus 102 in printing processing. Additionally, the image processing apparatus 101 also performs operations such as controlling the printing processing performed by the image formation apparatus 102 and managing the printing job. The image formation apparatus 102 is a printer that forms an image on a sheet as a printing medium based on the printing data generated by the image processing apparatus 101. A method of image formation includes an offset printing method, an electrophotographic method, an ink jet method, and so on, and it is not particularly limited. In the present embodiment, the image formation apparatus 102 is described as an image formation apparatus of the electrophotographic method. The inspection apparatus 103 inspects whether the sheet (a printed product) on which the printing processing is performed by the image formation apparatus 102 has no defect and has no problem with the quality thereof. The post-processing apparatus 104 is also referred to as a finisher and performs not only discharge control based on a result of the inspection performed by the inspection apparatus 103 but also post-processing such as sorting, grouping, and stapling.

### (Hardware Configuration of Each Apparatus)

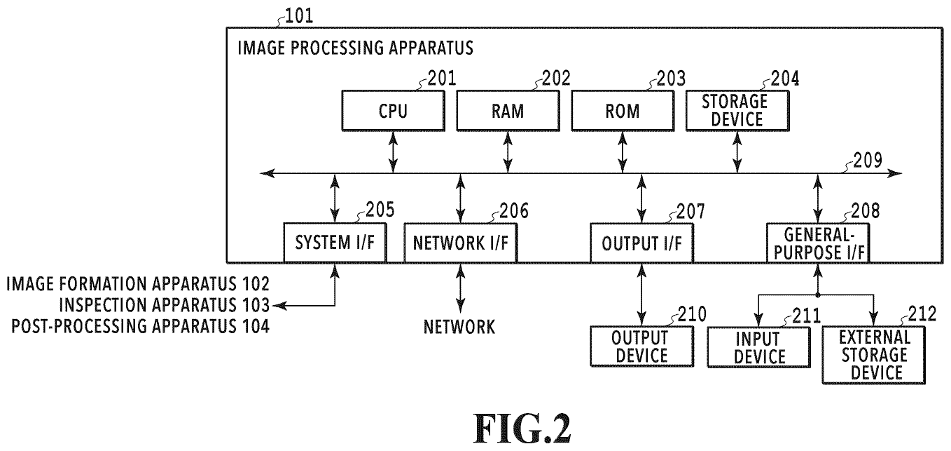

Hereinafter, a hardware configuration of each apparatus included in the printing system 100 is described. FIG. 2 is a diagram schematically illustrating an internal configuration of the image processing apparatus 101. The image processing apparatus 101 includes a CPU 201, a RAM 202, a ROM 203, a storage device 204, a system interface (I/F) 205, a network I/F 206, an output I/F 207, a general-purpose I/F 208, and a main bus 209. Additionally, the image processing apparatus 101 is connected with an output device 210 via the output I/F 207. The image processing apparatus 101 is connected with each of an input device 211 and an external storage device 212 via the general-purpose I/F 208.

The central processing unit (CPU) 201 is a central processing device, which is a processor that controls overall units included in the image processing apparatus 101. In the present embodiment, it is described that the CPU 201 controls overall the printing system 100. Note that, it is not limited to such a configuration, and a configuration in which the CPU 201 shares the processing with another CPU or a configuration in which a GPU that is a processor specialized for fast parallel calculation performs a part of the control processing by the CPU 201 may be applicable. Additionally, a part of the control processing by the CPU 201 may be performed by hardware such as an application specific integrated circuit (ASIC), a field programmable gate array (FPGA), or the like. The random access memory (RAM) 202 is a volatile memory that functions as a main memory of the CPU 201 and a working area. The read only memory (ROM) 203 is a volatile memory that stores a program group such as a basic input/output system (BIOS) executed by the CPU 201.

The storage device 204 represents a non-volatile high-capacity storage device such as an HDD and an SSD and saves an application executed by the CPU 201, various types of data, and the like. The system I/F 205 is an interface for connection with the apparatuses in the printing system 100, that is, the image formation apparatus 102, the inspection apparatus 103, and the post-processing apparatus 104, to transmit and receive various types of data. The apparatuses inform each other of own operational status via the system I/F 205 to synchronize operation timings and transmit and receive the data to and from the other apparatus. The network I/F 206 is an interface for connection with a network outside the printing system 100 to transmit and receive the data. The output I/F 207 is, for example, an image output interface such as a high-definition multimedia interface (HDMI) (registered trademark). The output device 210 connected with the image processing apparatus 101 via the output I/F 207 is, for example, a liquid crystal display that provides a graphical user interface (GUI) and the like.

The general-purpose I/F 208 is a bus interface such as a USB and IEEE 1394. Information of an operation (an instruction) by a user is received from the input device 211 such as a keyboard or a mouse that is connected with the image processing apparatus 101 via the general-purpose I/F 208. Additionally, the image processing apparatus 101 is connected with the external storage device 212 via the general-purpose I/F 208, and the user can save data such as a log into the external storage device 212 and can cause the image processing apparatus 101 to obtain desired data from the external storage device 212. The main bus 209 connects the multiple pieces of hardware included in the image processing apparatus 101 to be communicable to each other. Note that, the hardware configuration of the image processing apparatus 101 is not limited to the above-described configuration. For example, a display device such as a liquid crystal display that provides the GUI may be included inside the image processing apparatus 101 via the main bus 209. Additionally, the output device 210 and the input device 211 may be integral to each other as a touch panel type display or the like.

### (Hardware Configuration of Other Apparatus)

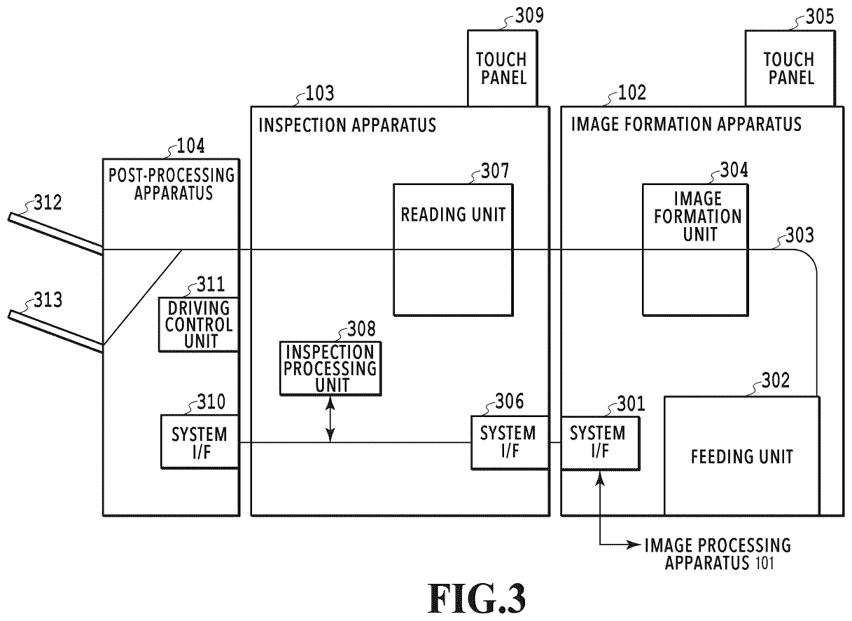

FIG. 3 is a diagram schematically illustrating a hardware configuration of the image formation apparatus 102, the inspection apparatus 103, and the post-processing apparatus 104.

The image formation apparatus 102 is connected with the other apparatus in the printing system 100 via a system I/F 301. The image formation apparatus 102 includes a feeding unit 302, a conveyance unit 303, an image formation unit 304, and a touch panel 305 in addition to a CPU and a RAM similar to that in the image processing apparatus 101. The feeding unit 302 supplies the sheet set on a not-illustrated cassette or the like into the image formation apparatus 102 through the conveyance unit 303. The conveyance unit 303 conveys the sheet set in the feeding unit 302 by using a rotation roller (not illustrated) and the like. The conveyance unit 303 can convey the sheet from the image formation apparatus 102 to the inspection apparatus 103 and the post-processing apparatus 104. That is, the conveyance unit 303 leads to the inspection apparatus 103 and the post-processing apparatus 104 and is a common constituent for the three apparatuses. The image formation unit 304 forms an image based on the printing data transmitted from the image processing apparatus 101 on the sheet conveyed by the conveyance unit 303. In a case where a printing method is the electrophotographic method, the image is formed on the sheet by forming the image indicated by the printing data on a photoconductive drum as a latent image, developing with color material (toner), transferring onto the sheet, and fixing. The printed product obtained by forming the image on the sheet is conveyed by the conveyance unit 303 to the inspection apparatus 103. The touch panel 305 is a combination of a display device (for example, a liquid crystal display) and a pointing device (for example, a touch pad), which corresponds to the output device 210 and the input device 211 of the image processing apparatus 101.

The inspection apparatus 103 is connected with the other apparatus in the printing system 100 via a system I/F 306. The inspection apparatus 103 includes a reading unit 307, an inspection processing unit 308, and a touch panel 309 in addition to a CPU and a RAM similar to that in the image processing apparatus 101. The reading unit 307 is a scanner that includes a light source and a light-receptive sensor (a CCD and the like) therein and optically reads the printed product conveyed by the conveyance unit 303 to obtain as image data. Hereinafter, the image data read by the reading unit 307 is referred to as “read data”. In the read data in the present embodiment, each pixel is in an image format with three channels: red, green, and blue (RGB), with 8 bits per channel. The inspection processing unit 308 inspects a defect of the printed product by comparing the read data obtained by the reading unit 307 to reference image data corresponding to the read data. The touch panel 309 is a combination of a display device (for example, a liquid crystal display) and a pointing device (for example, a touch pad), which corresponds to the touch panel 305 of the image formation apparatus 102.

The post-processing apparatus 104 is connected with the other apparatus in the printing system 100 via a system I/F 310. The post-processing apparatus 104 includes a driving control unit 311 and discharge trays 312 and 313. In FIG. 3, a hardware configuration to implement the function such as sorting, grouping, and stapling is omitted. The driving control unit 311 controls the switching of a path to discharge the printed product conveyed by the conveyance unit 303 to either the discharge tray 312 or the discharge tray 313 according to the inspection result obtained by the inspection apparatus 103. This driving control unit 311 discharges the printed product while distinguishing between an acceptable product and a rejected product according to the inspection, for example.

### (Functional Configuration of Printing System)

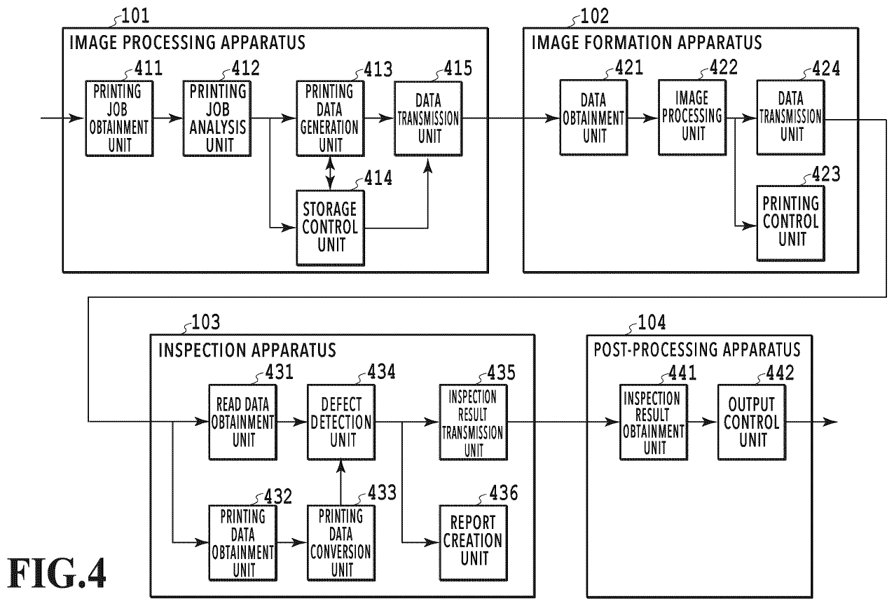

A functional configuration (a software configuration) of each apparatus included in the printing system 100 is described with reference to a functional block diagram in FIG. 4.

The image processing apparatus 101 includes a printing job obtainment unit 411, a printing job analysis unit 412, a printing data generation unit 413, a storage control unit 414, and a data transmission unit 415.

The printing job obtainment unit 411 obtains the printing job including data (a data portion) and header information (a header portion). The data is data (PDL data) describing the image as the printing target in units of pages. The header information includes not only information related to printing conditions such as the number of copies and a type and a size of the sheet (printing setting) but also information indicating an instruction to execute the inspection (inspection execution information) and the like. The printing job is inputted with a printing instruction from a personal computer (not illustrated) communicable with the image processing apparatus 101 via a network, for example. Alternatively, the printing job obtainment unit 411 may generate the printing job in the image processing apparatus 101 with the user inputting the above-described printing conditions and the like to the PDL data via the input device 211 and obtain the generated printing job.

The printing job analysis unit 412 analyzes the printing job obtained by the printing job obtainment unit 411 and applies information according to the analysis result to the printing job, which indicates whether to save the printing job so as to be continuously saved as a priority (storage control information). That is, the printing job analysis unit 412 applies the storage control information, which is information indicating the possibility of reuse that is obtained by analyzing the printing job and the priority indicating a degree of saving so as to be continuously saved as a priority into the storage device, to the printing job as the analysis target. The printing data generation unit 413 receives the printing job, performs the RIP processing based on the printing setting and the PDL data included in the header information of the printing job, and generates the printing data. The storage control unit 414 saves the printing job or the printing data and the storage control information of the printing job. Additionally, the storage control unit 414 also controls saving and deletion of the printing job or the printing data and the storage control information of the printing job. That is, the storage control unit 414 also controls whether to save the printing job or the printing data and the storage control information of the printing job so as to be continuously saved. The data transmission unit 415 transmits the printing data and the like generated by the printing data generation unit 413 to the image formation apparatus 102 via the system I/F 205. Note that, the data transmission unit 415 transmits the printing data saved in the storage control unit 414 in some cases.

The image formation apparatus 102 includes a data obtainment unit 421, an image processing unit 422, a printing control unit 423, and a data transmission unit 424.

The data obtainment unit 421 receives and obtains the printing data transmitted by the data transmission unit 415 of the image processing apparatus 101 via the system I/F 301. The image processing unit 422 performs color conversion processing, halftone processing, correction processing, and the like on the printing data according to a printing property of the image formation unit 304. Hereinafter, the printing data processed according to the printing property is referred to as “image formation data”. The printing control unit 423 performs processing to form an image on the sheet based on the image formation data (the printing processing) by controlling the image formation unit 304. The data transmission unit 424 transmits an ending signal informing of the printing data (or the image formation data) and execution of the printing processing to the inspection apparatus 103 via the system I/F 301.

The inspection apparatus 103 includes a read data obtainment unit 431, a printing data obtainment unit 432, a printing data conversion unit 433, a defect detection unit 434, an inspection result transmission unit 435, and a report creation unit 436.

The printing data obtainment unit 432 receives and obtains the printing data and the ending signal transmitted by the data transmission unit 424 of the image formation apparatus 102 via the system I/F 306. Based on the obtained ending signal, the read data obtainment unit 431 causes the reading unit 307 to execute reading (scanning) of the printed product conveyed by the conveyance unit 303 and obtains the read data.

The printing data conversion unit 433 performs resolution conversion, color conversion, and the like on the printing data obtained by the printing data obtainment unit 432 and generates the reference image data for the inspection by the following defect detection unit 434.

The defect detection unit 434 performs the inspection processing to inspect whether the printed product has a defect by comparing the read data to the reference image data. The inspection result transmission unit 435 transmits a result of the inspection processing performed by the defect detection unit 434 to the post-processing apparatus 104 via the system I/F 306. The report creation unit 436 creates an inspection report summarizing the results of the inspection processing performed by the defect detection unit 434.

The post-processing apparatus 104 includes an inspection result obtainment unit 441 and an output control unit 442. The inspection result obtainment unit 441 receives and obtains the inspection result transmitted by the inspection result transmission unit 435 of the inspection apparatus 103 via the system I/F 310. The output control unit 442 provides an instruction based on the obtained inspection result to the driving control unit 311 to perform control such that the printed product is discharged to a proper discharge tray (either one of 312 and 313). In addition, the output control unit 442 outputs a signal indicating that the processing ends from a terminal (not illustrated) of the post-processing apparatus 104.

### (Operation Flow of Printing System)

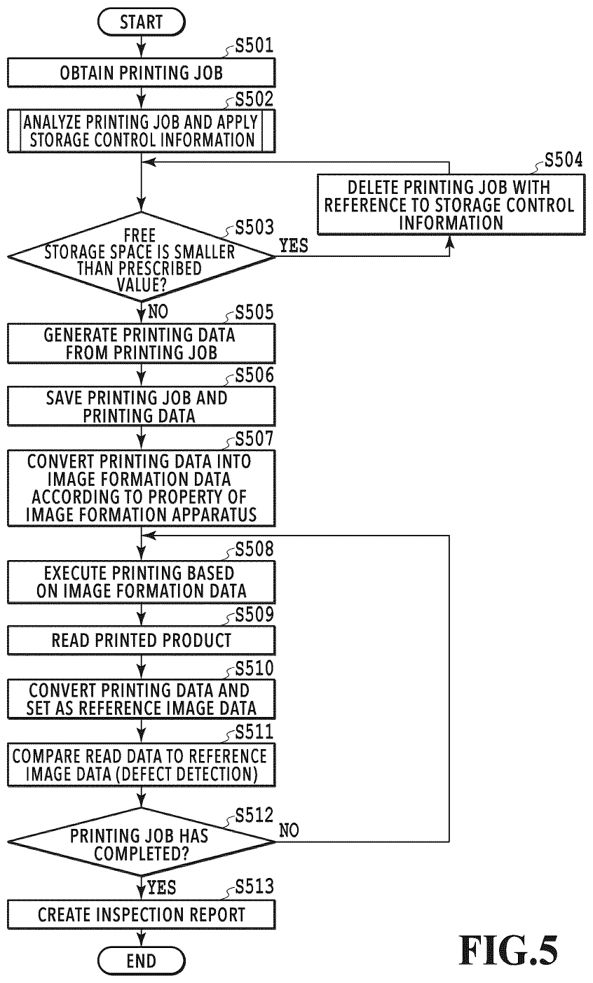

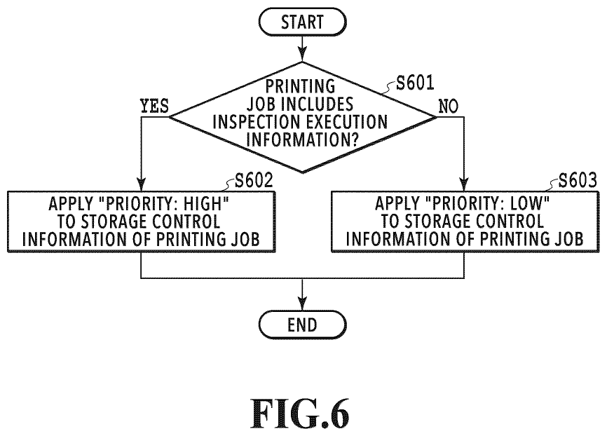

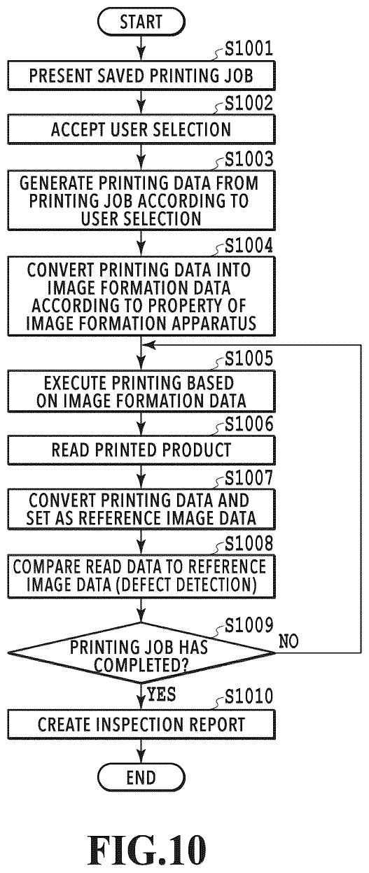

Subsequently, a flow of the operation of the printing system 100 according to the present embodiment is described with reference to flowcharts illustrated in FIGS. 5, 6, and 10. FIG. 5 is a flowchart illustrating a flow of printing and inspection processing based on a new printing job, and FIG. 6 is a flowchart illustrating a detailed flow of processing of applying the storage control information. FIG. 10 is a flowchart illustrating a flow of the printing and inspection processing based on a saved printing job. Processing out of the series of processing illustrated in the flowcharts in FIGS. 5 and 10 that is related to the printing processing is mainly performed by the CPU of the image processing apparatus 101 and processing that is related to the inspection processing is mainly performed by a CPU of the inspection processing unit 308 of the inspection apparatus 103.

### (Operation Flow Based on New Job)

The printing and inspection processing based on the newly inputted printing job is described with reference to the flowchart in FIG. 5. In the present embodiment, saving of the printing job is controlled based on the inspection execution information applied to the printing job so as to improve efficiency of re-printing and re-inspection, creation of the report, and the like. Note that, it is assumed that date information indicating the current date (for example, Jan. 1, 2024) is obtained.

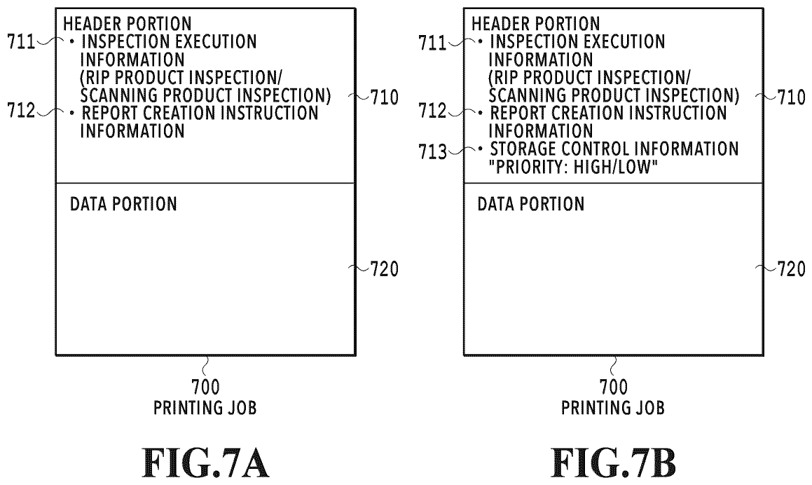

In S501, the printing job obtainment unit 411 obtains the printing job inputted to the printing system 100. As described above, the printing job is transmitted with the printing instruction from the personal computer (not illustrated) communicable with the image processing apparatus 101 via a network, for example. Alternatively, in some cases, the printing job may be obtained with the image processing apparatus 101 applying the printing setting to the image data saved in the external storage device 212. Here, description is provided with reference to FIG. 7A illustrating a data configuration example of the printing job. A printing job 700 includes a header portion 710 and a data portion 720. In addition to the printing setting, the header portion 710 includes inspection execution information 711 indicating whether to execute RIP product inspection/scanning product inspection, report creation instruction information 712 indicating an instruction about whether to create the report, and the like. The data portion 720 includes the PDL data and the like.

In S502, the printing job analysis unit 412 analyzes the printing job obtained in S501 and applies the storage control information, which is information according to the analysis result and indicating a degree of saving the printing job so as to be continuously saved as a priority, to the printing job as the analysis target. Details of the processing of analyzing the printing job and applying the storage control information (S502) are described with reference to the flowchart in FIG. 6.

### (Details of Processing of Analyzing Printing Job and Applying Storage Control Information)

FIG. 6 is a flowchart illustrating a detailed flow of the processing of analyzing the printing job and applying the storage control information (S502). In the present embodiment, the storage control information corresponding to the inspection execution information indicating whether to execute the inspection is applied to the printing job. Some of the printing jobs may perform the inspection to guarantee that it is a particularly important printed product and has no defect in the printing result while the other may perform only printing without inspection. In the printing job that does not perform the inspection, the inspection execution information indicating the inspection execution instruction is not applied to the printing job. In the printing job that performs the inspection, the inspection execution information indicating the inspection execution instruction is applied to the printing job. In the present embodiment, the printing job that is saved so as to be continuously saved as a priority is determined by using the inspection execution information indicating the inspection execution instruction included in the printing job.

In S601, the printing job analysis unit 412 analyzes whether the information indicating the inspection execution instruction (the inspection execution information) is applied to the printing job. If the analysis result indicating that the inspection execution information is applied to the printing job is obtained (YES in S601), the processing proceeds to S602. If the analysis result indicating that the inspection execution information is not applied to the printing job is obtained (NO in S601), the processing proceeds to S603.

In S602, the printing job analysis unit 412 applies the storage control information of “priority: high”, which indicates that the saving priority of the printing job as the processing target to be continuously saved as a priority into the storage device 204 is relatively high, to the printing job as the processing target. In S603, the printing job analysis unit 412 applies the storage control information of “priority: low”, which indicates that the saving priority of the printing job as the processing target to be continuously saved as a priority into the storage device 204 is relatively low, to the printing job as the processing target. Here, description is provided with reference to FIG. 7B illustrating a data configuration example of the printing job after the storage control information is applied. The printing job 700 after the application of the storage control information includes the header portion 710 including storage control information 713 indicating “priority: high/low”, in addition to the printing setting, the inspection execution information 711, and the report creation instruction information 712, and the data portion 720.

Referring back to the flowchart in FIG. 5. In S503, the storage control unit 414 confirms a use state of the storage device 204 of the image processing apparatus 101 and determines whether the free space of the storage device 204 is smaller than a prescribed value. In the present embodiment, for example, the prescribed value is 10% of an entire storage amount of the storage device 204, which is the free space that is sufficient for saving the inputted printing job. Instead of the data size of the free space of the storage device 204, the number of the saved printing jobs may be a determination reference.

If the determination result indicating that the free space of the storage device 204 is smaller than the prescribed value is obtained (YES in S503), the processing proceeds to S504. In S504, the storage control unit 414 refers to the storage control information of the printing job already saved in the storage device 204 and determines the printing job that should be deleted according to the storage control information.

In the present embodiment, out of candidates of deletion target including the printing job with the storage control information of “priority: low” and the printing job with the storage control information of “priority: high” that is after the elapse of a predetermined certain period since the printing completion, the oldest printing job is deleted. That is, in a case where the free space of the storage device 204 is smaller than the prescribed value while the printing job to which the low priority is applied and the printing job to which the high priority is applied are saved in the storage device 204, the printing job described as follows is deleted. Out of the candidates of deletion target including the printing job to which the high priority is applied and that is after the elapse of a predetermined period since the printing completion and the printing job to which the low priority is applied, the printing job that is determined based on the elapsed time since the printing completion is deleted. Specifically, out of the candidates of deletion target, the printing job with the longest elapsed time since the printing completion is deleted.

Additionally, in a case where there is no corresponding printing job, the oldest printing job as the printing job that should be deleted is determined. That is, in a case where the free space of the storage device 204 is smaller than the prescribed value while the printing job to which the high priority is applied is not saved in the storage device 204, out of the printing jobs to which the low priority is applied, the printing job that is determined based on the elapsed time since the printing completion is deleted. Specifically, the printing job with the longest elapsed time since the printing completion is deleted. Moreover, in a case where the free space of the storage device 204 is smaller than the prescribed value while the printing job to which the low priority is applied is not saved in the storage device 204, out of the printing jobs to which the high priority is applied, the printing job that is determined based on the elapsed time since the printing completion is deleted. Specifically, the printing job with the longest elapsed time since the printing completion is deleted.

After executing the processing in S504, the processing returns to S503. Then, the determination processing in S503 is executed again. That is, in the storage device 204, the processing in S503 and S504 is repeatedly executed until there is enough free space to save the inputted printing job.

### (Processing of Deleting Printing Job)

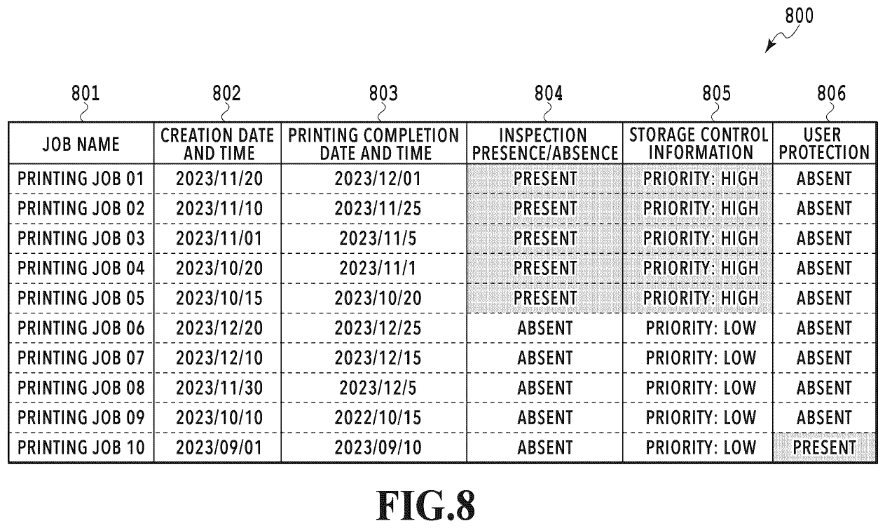

An idea of the processing of deleting the printing job (S504) is specifically described with reference to FIG. 8. FIG. 8 is a diagram illustrating a tabulated list of the printing jobs. A tabulated list 800 of the printing jobs is a list of the printing jobs that are saved in the storage device 204 of the image processing apparatus 101 at one point. Note that, information is simplified for the sake of description.

Regarding each of the saved printing jobs, the tabulated list 800 of the saved printing jobs displays information related to items, which are job name 801, creation date and time 802, printing completion date and time 803, inspection presence/absence 804, storage control information 805, and user protection 806 in association with the printing job. Note that, FIG. 8 illustrates the information related to the items that are the creation date and time 802 and the printing completion date and time 803 while omitting time.

The job name 801 indicates a name of each printing job. The job name 801 may be named arbitrarily; however, in the present embodiment, as illustrated in FIG. 8, the names are “printing job 01” to “printing job 10” from the top of the table. The creation date and time 802 indicates the date and time at which each printing job is created. The printing completion date and time 803 indicates the date and time at which the printing of each printing job is completed. The inspection presence/absence 804 indicates information about whether the inspection execution information indicating the instruction to execute the inspection is applied to each printing job. The storage control information 805 is the storage control information applied to each printing job in S502 and indicates either “priority: high” or “priority: low”. The user protection 806 indicates whether there is the instruction to protect the saving of the printing job that is applied arbitrarily to the printing job by the user. In the present embodiment, assuming that the current date is Jan. 1, 2024, and the predetermined certain period that allows the printing job with “priority: high” to become the candidate of deletion target is two months. That is, the printing job with “priority: high” and the printing completion date and time from the current date to Nov. 1, 2023 corresponds to a prioritized holding job that is saved so as to be continuously saved as a priority.

Note that, in the tabulated list 800 of the saved printing jobs, the display order of the printing job is arrayed in an organized manner from the user protection 806 as a first item (“No” is at the top), the storage control information 805 as a second item (“priority: high” is at the top), and the printing completion date and time 803 as a third item (new date is at the top).

In the deletion in S504, first, the printing job with the user protection 806 “Yes” is excluded from the deletion target. In the tabulated list 800 of the saved printing jobs, the printing job 10 out of the printing job 01 to the printing job 10 is excluded from the deletion target. Next, the storage control information is referred to, and the printing job with the storage control information of “priority: low” and the printing job with the storage control information of “priority: high” and with the elapsed time of two months since the printing completion date and time are the candidates of deletion target. In the tabulated list 800 of the printing jobs, the printing job 05, the printing job 06, the printing job 07, the printing job 08, and the printing job 09 out of the printing job 01 to the printing job 09 are the candidates of deletion target. In addition, out of the candidates of deletion target, the printing job with the longest elapsed time since the printing completion date and time is selected as the deletion target and deleted.

In the present embodiment, the printing job 09 is selected and deleted. In a case where there is no printing job 09, the printing job 05 is selected as the deletion target and deleted. In a case where there are neither printing job 05 nor printing job 09, the printing job 08 is selected as the deletion target and deleted. In the deletion of the printing job 08, with reference to the printing completion date and time of the printing jobs, although there are multiple (four) printing jobs, which are the printing jobs 01 to 04, with the longer elapsed time since the printing completion date and time than that of the printing job 08, those printing jobs are continuously saved as a priority based on the priority. However, even in a case where the priority is high, the continuous saving is not always guaranteed, and the printing job may be deleted depending on a situation such as sufficient elapse of the time. Note that, although the printing completion date and time is used as the date and time as a starting point to obtain the elapsed time in the present embodiment, it is not limited thereto. For example, time information indicating date and time as another starting point, such as creation date and time at which the printing job is created and input date and time at which the printing job is inputted to the printing system, may be used.

If the determination result indicating that the free space of the storage device 204 is not smaller than the prescribed value is obtained (NO in S503), the processing proceeds to S505. In S505, the printing data generation unit 413 performs the RIP processing with reference to the image information, the printing setting information, and the like included in the printing job obtained in S501. With this RIP processing, the inputted printing job reflects the printing setting and is bitmapped to become the printing data representing the image that should be formed by the image formation apparatus 102.

In S506, the storage control unit 414 saves the printing job obtained in S501 into the storage device 204 in association with the printing data corresponding to the printing job. In the present embodiment, the printing job and the printing data are saved integrally.

Once S501 to S506 described above end, the printing data is transmitted and received between the data transmission unit 415 and the data obtainment unit 421, and the main processing flow transitions from the image processing apparatus 101 to the image formation apparatus 102.

In S507, the image processing unit 422 of the image formation apparatus 102 performs predetermined image processing on the printing data received by the data obtainment unit 421 and generates the image formation data appropriate for the property of the image formation unit 304. The predetermined processing includes, for example, color conversion processing, halftone processing, correction processing, and the like. In general, depending on a model and a machine thereof, the image formation apparatus has various properties for the image formation based on color material used and a property of the device. The image formation data generated in the present step is data that absorbs the difference in the properties and that is directly referred to by the image formation unit 304 in a case of executing the printing processing.

Here, the predetermined processing is described simply. The color conversion processing is processing of converting a color expressed by the image of the printing data into a color material amount used for the image formation. In a case of the present embodiment in which the image formation unit 304 forms the image by using toner of four colors, which are C (cyan), M (magenta), Y (yellow), and K (black), the conversion is performed by using three dimensional, four dimensional, or one dimensional LUT indicating a conversion relationship between various colors and the color material amounts of the above-described four colors. The halftone processing is processing of quantizing a multi-valued pixel value of each pixel forming the image of the printing data into a small value (for example, binary that indicates whether there is toner) that can be directly expressed by the image formation unit 304, and dithering and error diffusion are used, for example. The correction processing is processing of emphasizing an edge by using an edge emphasis filter in a case where, for example, the image formation unit 304 has a property that a sharp edge and the like cannot be reproduced and the edge becomes blurry. Thus, the image formation data is generated from the printing data.

In S508, the printing control unit 423 drives the image formation unit 304 and prints the image on the conveyed sheet based on the image formation data. In the electrophotographic method, with a toner amount defined in the image formation data, a toner image is formed on the photoconductive drum by a step of latent image formation and development, and after the toner image is transferred on the sheet, the toner on the sheet is fixed, and thus the printed product is created.

Once the execution of the processing in S507 and S508 described above ends, the printing data or the image formation data is transmitted and received between the data transmission unit 424 and the printing data obtainment unit 432. Additionally, the ending signal indicating that the printing is executed is transmitted from the image formation apparatus 102 to the inspection apparatus 103.

In S509, the read data obtainment unit 431 reads the conveyed printed product by the reading unit 307 of the inspection apparatus 103 and obtains the read data (inspection image data).

In S510, the printing data conversion unit 433 obtains the printing data generated in S505 from the image formation apparatus 102 and performs predetermined image processing on the printing data to generate the reference image data. Specifically, the image processing such as the resolution conversion and the color conversion is performed on the printing data. Although the printing data is appropriate as the reference image data since it has no defect, it is impossible to compare to the read data with no change. For example, although an image resolution of the read data is determined based on a conveyance speed of the conveyance unit 303 and a reading frequency of the reading unit 307, this is not related to the printing processing system; for this reason, image resolutions of the read data and the printing data are not always common. Therefore, it is necessary to perform processing to match the resolutions to obtain the reference image data appropriate for the comparison. Note that, in the resolution conversion, it is unnecessary to match one image resolution to the other, and the image resolution may be converted into an arbitrary resolution that is sufficient to confirm a defect with an image size that is not excessively great.

Additionally, although the printing data in a case where the printing processing is performed by using the toner of four colors of CMYK has a pixel value of CMYK four channels, the read data usually has a pixel value of RGB three channels; for this reason, it is necessary to match the pixel value to either one. Therefore, the color conversion processing is performed by using the LUT in which a correspondence relationship between the pixel value of the printing data and the pixel value of the read data. The LUT in this case is created in advance by obtaining the correspondence relationship between two pieces of data, indicating which pixel value of the read data corresponds to which pixel value of the printing data. In addition, since the read data includes the printing property of the image formation unit 304 and the reading property of the reading unit 307, correction processing to add those properties as a simulation may be performed on the printing data. Thus, the reference image data is generated from the printing data. Note that, in a case where the data transmitted from the image formation apparatus 102 is not the printing data but the image formation data, the reference image data may be generated by performing necessary image processing on the image formation data. The thus-generated reference image data is set (saved in the RAM of the inspection apparatus 103) as the reference image data for the inspection of the printing job obtained in S501.

In S511, the defect detection unit 434 compares the inspection image data obtained in S509 to the reference image data set in S510 and inspects whether there is a defect for each item designated by the inspection setting in the printing job (the inspection execution information). Note that, the defect detection unit 434 executes pre-processing before the comparison as needed. In this case, the pre-processing is, for example, resolution conversion processing to match the image resolutions of the inspection image data and the reference image data, positioning processing to match the positions of the two images, and the like. There is a possibility that the inspection image data obtained by reading the printed product includes positional shift and inclination shift due to printing accuracy and conveyance accuracy. In a case where the inspection image including the above-described positional shift and inclination shift is compared to the reference image, there is a possibility that a defect cannot be detected accurately; for this reason, the positioning processing to solve the positional shift and the inclination shift that may be included in the inspection image is necessary. Specifically, a feature point is extracted from both the images to obtain correspondence points between the two images, and the conversion to match the correspondence points is performed to correct the shift. Note that, a method of publicly-known AKAZE (Accelerated-KAZE) may be applied as the feature point extraction, for example, and publicly-known affine transformation may be applied as the conversion.

Once the above-described pre-processing ends, the defect detection unit 434 compares the inspection image data to the reference image data for each pixel and calculates a difference for each pixel. In a case where the printed product has no defect and the matching degree between the inspection image and the reference image is high, the difference for each pixel is “0” or within a range of a value of a small absolute value. On the other hand, in a case where the printed product has a defect, there is an unmatched portion between the inspection image and the reference image, and a great difference in the absolute value is calculated in the pixel corresponding to the defect. In a case where the printed product has a defect, there are some aggregate pixels with a great difference in the absolute value for each defect type. Therefore, a portion that is suspected to have a defect is identified by applying spatial filtering processing in a predetermined shape to the calculated difference, and a reaction value of the spatial filter and a predetermined threshold are compared to determine whether it is considered as a defect. The thus-obtained determination result (the inspection result) is saved into the RAM of the inspection apparatus 103. Then, the printed product on which the inspection has done is conveyed to the post-processing apparatus 104 and outputted to the discharge tray according to the inspection result by the output control unit 442 of the post-processing apparatus 104. The defect of the printed product is generated because the color material is adhered onto an unintended portion during the printing processing or the color material is insufficiently adhered onto an intended portion, and the types are a point-like defect, a linear defect, a color dropout, color unevenness, and so on.

Once S509 to S511 described above end, the inspection result is transmitted and received between the inspection result transmission unit 435 and the inspection result obtainment unit 441, and the main processing flow transitions from the inspection apparatus 103 to the post-processing apparatus 104.

In S512, in the image formation apparatus 102, whether the printing processing of the number of copies designated by the printing job has completed is determined. If the determination result indicating that it has not completed is obtained (NO in S512), the processing returns to S508, and the printing processing and the inspection processing for the result continue. On the other hand, if the determination result indicating that it has completed is obtained (YES in S512), the processing proceeds to S513.

In S513, the report creation unit 436 creates the inspection report based on the inspection result saved in the RAM of the inspection apparatus 103. The inspection report describes information such as the total number of printing, the number of the acceptable products, and the number of the rejected products. Additionally, as for the rejected product, the position and the type of the detected defect may be described. In addition, the appearance of the actual defect may be indicated as a trail with reference to the read image and the reference image. The created inspection report is saved in the RAM of the inspection apparatus 103 and additionally in the storage device. Note that, the inspection report is created as needed in a case where, for example, the instruction about the creation of the inspection report is included in the printing job.

### (Inspection Report)

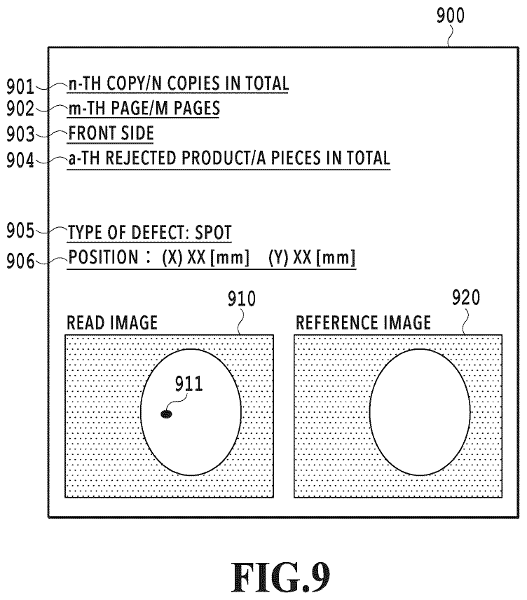

FIG. 9 is a diagram illustrating an inspection report example. In FIG. 9, information of one rejected product that is detected during an operation is displayed. An inspection report 900 is created by the report creation unit 436 and indicates detailed information in a case where a defect is detected. Regarding the rejected product, the inspection report 900 indicates multiple pieces of information, which are the target number of copies 901 out of the total number of copies, the target page number 902 out of the total page number, a target side 903 out of a front side and a back side, a number 904 out of the detected rejected products, and a type 905 of the defect. Additionally, the inspection report 900 indicates information of a position 906 of the defect in the page, an enlarged view 910 of an enlarged part of the read image, and an enlarged view 920 of an enlarged part of the reference image corresponding to the read image. In the enlarged view 910 of a part of the read image, a spot 911 detected as a defect is illustrated. It is possible to confirm the actual defect by comparing the enlarged view 910 to the enlarged view 920.

With the above, a flow of the printing and inspection processing including the storage control processing of the printing job in the present embodiment ends. According to the present flow, it is possible to automatically determine whether the printed product on which the image is printed has no defect and the quality thereof has no problem, and it is possible to collect only the printing result having no defect. Additionally, in a case where the free space of the image processing apparatus 101 is smaller than the predetermined prescribed value, it is possible to automatically save (leave) the printing job that is considered to be important so as to be continuously saved as a priority.

### (Operation Flow Based on Saved Job)

The printing and inspection processing based on the saved job is performed in a case where additional printing is necessary for any reason, or the like. With the storage control information being included in the header information of the generated printing job, as described above, the printing job is saved so as to be continuously saved even after the execution thereof according to the free space of the storage device, the elapsed time since the printing completion date and time, and the storage control information. In addition, in a case where the additional printing is actually required, the user provides the instruction to start executing the saved printing job via the input device 211 of the image processing apparatus 101. Hereinafter, the printing and inspection processing based on the printing job that is saved so as to be continuously saved even after the execution is described with reference to the flowchart in FIG. 10.

In S1001, the information of the printing job saved in the storage device 204 is read out, and a saved job list (not illustrated) is presented to the user via a display device as the output device 210. Once the user finds a desired printing job from the saved job list, the user performs an operation to select the printing job via the input device 211.

In S1002, the operation to select the printing job by the user is received, and the printing job obtainment unit 411 reads out and obtains the printing job according to the selection operation from the storage device 204. Note that, a difference from S501 in the flow in FIG. 5 described above is that, since the printing job according to the selection operation is in the image processing apparatus 101, it is unnecessary to obtain from the outside, and only the identification performed in the internal storage device 204 is required. Note that, in a case where the printing data generated from the printing job according to the selection operation is also saved in the storage device 204, in the present step, the printing data corresponding to the printing job according to the selection operation may be read out and obtained with the printing job according to the selection operation. In this case, subsequent S1003 is unnecessary and thus skipped.

In S1003, as with S505 described above, the printing data generation unit 413 generates the printing data by performing the RIP processing based on the header information and the image data (the PDL data) included in the printing job obtained in S1002. A difference from S505 is that the target is the printing job that is already saved.

In a case where the printing data is generated or obtained in S1003, in S1004 to S1010 subsequent to S1003 in FIG. 10, the printing and inspection processing is performed as with the flow in FIG. 5 described above. Each step of S1004 to S1010 illustrated in FIG. 10 corresponds to each of S507 to S513 in the flow in FIG. 5 described above, and there is no particular difference; for this reason, the description is omitted. The above is details of the printing and inspection processing based on the saved job.

Some advantages are implemented in printing image inspection according to the flows in FIGS. 5 and 10 described in the present embodiment. The advantages are now described.

In the present embodiment, the reference image data used for the defect detection processing is generated from the printing data or the image formation data; for this reason, if the printing job as a source of the data exists, it is possible to regenerate the reference image data by reflecting the setting and the like of the printing job. Thus, it is possible to omit saving of the reference image data for each inspection, and it is possible to save the resources of the printing system. As the method of obtaining the reference image data, there is also a method of reading and obtaining the printed product that is printed in advance and confirmed that it has no problem in the quality by the reading unit 307. However, in this method, it is necessary to perform the operations in advance to confirm and read the printed product having no defect. In addition, concerning a case where additional reprinting and reinspection are necessary for any reason and a case where it is necessary to create the inspection report after the elapse of predetermined time since the printing completion, this method requires to save the reference image data until those cases occur. This is because, it is difficult in the actual reading of the printed product to reobtain completely the same read data. Although it is possible to obtain similar images of the same type, it is not favorable for the inspection in terms of fairness because the reference is changed. It is the same for a case of attaching the image to the inspection report. Since the reference image data is necessary for each picture (that is, each page) of the printed product and is changed depending on the printing conditions, the number of pieces of the reference image data may be enormous depending on the printing job. In the present embodiment, because it is possible to generate the above-described reference image data from the printing job, it is unnecessary to save the reference image data every time, and it is beneficial for efficient use of the resources of the printing system including the storage capacity of the whole system. Additionally, there is a possibility that it is possible to hold the printing job for generating the reference image data for a longer period of time as a consequence than a case of directly saving and holding the reference image data with a great data size and deleting as needed.

In addition, in the present embodiment, in S502, the printing job analysis unit 412 applies the storage control information corresponding to the inspection execution information of the printing job to the printing job, and the storage control unit 414 controls the saving based on the storage control information. As a specific example, the storage control information with a higher priority is applied to the printing job that performs the inspection so as to continuously save the printing job for a longer period of time. A mode in which the reference image data is generated from the printing job has the above-described advantage; however, the generation requires the printing job. In a case where this printing job is deleted from the image processing apparatus 101 at that time because of the restriction of the saving capacity, it is necessary to input the printing job again. This may cause increase of operation works of the user and may invite inhibition of the productivity of the printing and inspection. In contrast, in the present embodiment, the printing job that has a high possibility of being reused to generate the reference image data and is considered to be more important is automatically saved so as to be continuously saved for a longer period of time. Thus, comparing with a case of not considering the possibility of reuse of the printing job, it is possible to suppress the possibility that the user is forced to input the printing job again, and it is possible to contribute to greater efficiency of the operation.

As described above, according to the present embodiment, the reference image data is generated from the printing data to use the duplication and the redundancy of the information, and it is possible to save and efficiently use the saving capacity of the storage device more than a case of saving the reference image data itself so as to be continuously saved. Additionally, since the saving of the printing job that is a generation source of the reference image data is also controlled, it is possible to suppress an occasion that the user inputs the printing job again, and it is possible to achieve an effect of greater efficiency than a case of simply controlling holding, not holding, and deletion of the reference image data. This effect is greater with regard to maintaining the saving for a long period of time such as a case where additional printing and inspection are required or a case where the inspection report needs to be created later. That is, it is possible to maintain the convenience of the user in a case of reusing the printing job while avoiding occupation of the capacity of the storage device into which the printing job is saved.

### Modification of Embodiment 1

The above-described embodiment 1 is not limited only to the above-described configuration. For example, the embodiment 1 may be applicable with the following modification. Note that, a configuration similar to that of the embodiment 1 is denoted by the same reference numeral and the description thereof is omitted.

### (Method of Applying Priority)

In the above description, an aspect in which, out of the deletion candidates including the printing job with the storage control information of “priority: low” and the printing job with the storage control information of “priority: high” and that is after the elapse of a predetermined period since the printing completion, the oldest printing job is deleted is described; however, it is not limited thereto.

For example, the storage control information that is multi-valued or continuous-valued, which is greater than binary, may be applied to the printing job. As an example, storage control information E is calculated as follows with reference to an elapsed time t since the printing completion of the printing job, where a predetermined certain period is T.
In a case where the printing job has the inspection execution information

$$E = 0.5 \times ( t - T )$$

In a case where the printing job has no inspection execution information

$$E = t$$

The printing job with the maximum calculated storage control information E is the deletion target. That is, in a case where the printing job has the inspection execution information, the holding priority is increased by evaluating the printing job with half the value obtained by subtracting the certain period T as the protection period from the elapsed time t. According to such a method, it is possible to select the printing job as the deletion target from uniform perspectives by the storage control information E that is continuous-valued. Therefore, it is possible to implement the selection in which the inspection execution instruction and the elapsed time are balanced by adjusting a parameter related to the calculation of the storage control information E.

Alternatively, periods T1 and T2 (note that, T1<T2) may be provided, and the printing job having no inspection execution information may be set as the deletion target with the elapse of the period T1, and the printing job having the inspection execution information may be set as the deletion target with the elapse of the period T2. In this case, there is an advantage that the printing job as the deletion target is selected with clarity.

### (Alternative Method of Deletion)

In the above description, an aspect in which the printing job saved in the storage device is deleted with reference to the storage control information is described; however, it is not limited thereto. For example, an aspect in which, in a case where the printing system 100 includes a first storage device and a second storage device having a slower reading and writing speed than that of the first storage device, the printing job saved in the first storage device is moved to the second storage device may be applicable. Additionally, alternatively, a data compression technique may be used to encode the printing job and reduce the data size. Thus, instead of deletion, the printing job may be controlled to be saved in a state of low accessibility for a short period of time.

### (Deletion Timing)

In the above description, a case where input of the new printing job is a timing where the printing job saved in the storage device is deleted is described; however, it is not limited thereto, and the saving may be controlled such that the printing job is deleted in an arbitrary timing, for example.

### (Individual Management of Printing Job and Printing Data)

In the above description, a mode in which the printing job and the printing data generated from the inputted job are associated with each other and saved integrally (S506) is described; however, it is not limited thereto, and a mode of saving may be the control target. The reference image data is generated based on the printing data, and the printing data is generated from the printing job. In a case where the printing data is saved, although processing of generating the printing data from the printing job again is unnecessary, the required saving capacity is increased by the amount of the printing data. Even in a case where the printing data has been deleted, as long as the printing job as the source of the printing data is held, it is possible to obtain the printing data although the generation processing has to be performed again. Accordingly, in a case where the printing data is deleted, although the accessibility is reduced in a situation that requires processing, the information is continuously held in the system. This may be used to perform control to delete the printing data while leaving the printing job.

### (Priority Corresponding to Inspection Level)

In the above description, a case where the storage control information according to the presence or absence of the inspection execution information is applied to the printing job and the printing job that performs the inspection is saved so as to be continuously saved as a priority is described; however, it is not limited thereto. The storage control information may be applied to the printing job with reference to information other than the inspection execution information and the saving may be controlled.

For example, a higher priority may be applied to the printing job that has the inspection execution information and a high inspection level of the inspection to be executed. In a case where the inspection is executed in the printing job, an inspection level indicating the level (rigor) of the inspection is set. This is set and held with the inspection execution instruction in the header portion of the printing job. The inspection level means the level (rigor) of the defect detection in the inspection processing, which is designated by the user during the inspection instruction via a UI, and a predetermined default value is set if there is no particular instruction by the user. Specifically, the inspection level is expressed by any one of numerical values from 1 to 9. As the numerical value is greater and the inspection level is higher, it indicates that the inspection is more rigorous, and even a slight difference from the reference image data is detected as a defect and determined as the rejected product. The default value is set as “6”, for example. This is implemented by reducing the threshold compared to the reaction value of the spatial filter in the description of S511 described above, for example. The printing job having the inspection execution information at a higher inspection level corresponds to a more important printing result, and it is considered that the possibility of reprinting, reinspection, and inspection report creation and the importance of speedy output of those operations are high. Therefore, providing the high priority to the printing job having the inspection execution information at the high inspection level leads to the saving of the important printing job or that has a high possibility of reuse so as to be continuously saved as a priority. Thus, further improvement of the productivity is expected. Note that, in a case where there is no particular instruction by the user, a predetermined default value is set.

(Priority in Case with Replacement Printing)

Additionally, as another mode, a higher priority may be applied to the printing job that includes partial replacement for each printed product and the printing job that performs the inspection of the replaced portion. That is, the printing job that outputs the printed product partially different for each unit of printing may be saved so as to be continuously saved with a higher priority than the printing job that does not output the printed product partially different for each unit of printing. It is considered that such a printed product has different meanings for each, and the importance of each piece is higher than that of the printed product of a type that is a large amount of printing of the same image. According to this idea, the printing job that includes partial replacement is saved so as to be continuously saved as a priority, and the productivity is further improved.

(Priority in Case without Instruction to Save Reference Image Data)

A case where saving and not saving the reference image data can be arbitrarily set in a mode in which the reference image data is generated from the printing data as the embodiment 1 is considered. In this case, under the setting according to an instruction that the reference image data is not saved, a higher priority may be applied to the printing job than that of a case of the setting according to an instruction that the reference image data is saved. This is because, in a case where no reference image data is saved, it is considered that the importance of the printing job that can generate the reference image data is increased and the possibility of generating the reference image data from the printing job is increased. Thus, the printing job with higher importance or higher possibility of reuse is saved so as to continuously save, and the productivity is thus improved.

(Priority in Case with Instruction to Create Inspection Report)

Additionally, a high priority may be applied in a case where an instruction to create the inspection report is added to the printing job. This is because the printing job that is planned to output the inspection report is estimated to have a higher possibility of reusing the printing job than that of the printing job that is not planned to output the inspection report. Accordingly, the printing job with a high possibility of reuse may be saved so as to be continuously saved as a priority, and thus the productivity may be improved.

(Printing Job that Performs Scanning Product Inspection)

In a mode in which the reference image data is generated from the printing job as the embodiment 1, as described above, it is unnecessary to save the reference image data for each inspection while saving the printing job, and it is possible to generate the reference image data once it is required later; thus, it is efficient in terms of holding and using the printing job. In the present embodiment, it is not limited thereto. Even in a case where the reference image data is not generated from the printing job, considering the possibility of reprinting and the like, it is the same that the printing job having the inspection execution information is considered to be more important than the printing job having no inspection execution information. Accordingly, for example, the embodiment is also applicable to the printing job that performs so-called scanning product inspection, in which the image data obtained by reading the printing result having no defect by a scanner is used as the reference image data. That is, the reference image data that corresponds to the printing job saved in the storage device and is obtained by reading the printed product having no defect is saved into the storage device in association with the printing job. In a case where the free space of the storage device is smaller than the prescribed value, the printing job determined based on the priority applied to the printing job and the reference image data associated with the printing job are deleted. Note that, in a case where the user deletes the reference image data obtained by reading in the printing job that performs the scanning product inspection, it may be considered that the possibility of performing the inspection becomes low, and thus the storage control information of a lower priority may be applied to the printing job.

### (Other Inspection Setting)

In addition, the storage control information of a higher priority may be applied to the printing job with the inspection setting that is considered to increase the importance of the printing job and the possibility of reusing the printing job.

### (Default Setting)

The control of the saving priority of the printing job that is determined as described above may be changed eventually in an individual case. That is, for example, as the above-described embodiment, as a result of arbitrarily setting the protection to an individual printing job by the user, the actual order of holding the printing job may be changed from the priority set as described above. This is because it is considered that following the policy arbitrarily set by the user is more convenient for the user in individual circumstances. With a mode in which the arbitrary setting by the user according to individual circumstances is accepted while the priority of a preset value (a default value) of the setting, which is an initial value, is determined as described above, it is expected to more favorably respond to the convenience of the user as a whole.

### Other Embodiments

In the embodiment 1, a configuration in which the printing system 100 includes the image processing apparatus 101, the image formation apparatus 102, the inspection apparatus 103, and the post-processing apparatus 104 is described. Additionally, an example of a configuration of each apparatus is also described. However, a configuration inside the printing system, a device provided inside each apparatus, or a category of a functional unit is not limited to that described above. A configuration that is described as being separated in the embodiment 1 may be an integral apparatus, or on the other hand, an integral apparatus may be categorized into different apparatus groups. For example, a configuration like an inline inspection apparatus that performs the whole processing including image processing, image formation, inspection, and discharge may be applied.

In the above description, a case where the printing job includes the inspection execution information is described; however, it is not limited thereto. For example, in a case before applying the storage control information to the printing job, as needed, an individual piece of the inspection execution information different from the printing job may be set to the printing job by a user operation performed on the touch panel 309 of the inspection apparatus 103. In this case, the inspection execution information set to the printing job is obtained with the printing job as the processing target. Additionally, in a case of saving the printing job, the inspection execution information that is set to the printing job in association with the printing job is also saved.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present embodiment, it is possible to maintain the convenience of a user in a case of reusing a printing job while avoiding occupation of a capacity of a storage device into which the printing job is saved.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-077795, filed May 13, 2024, which is hereby incorporated by reference wherein in its entirety.

What is claimed is:

1. An image processing apparatus comprising:
one or more memories storing instructions; and
one or more processors executing the instructions to:
analyze an inputted printing job of a printed product and apply information indicating a possibility of reusing the printing job to the printing job; and
perform control such that the printing job to which the information is applied is continuously saved into a saving unit even after execution of printing by the printing job, wherein
in the controlling, out of the printing jobs saved in the saving unit, the printing job that is determined based on the information is deleted.

2. The image processing apparatus according to claim 1, wherein
in the controlling, in a case where a free space of the saving unit is smaller than a prescribed value, the printing job determined based on the information is deleted.

3. The image processing apparatus according to claim 2, wherein
in the applying, as the information, a priority indicating a degree of control so as to be continuously saved as a priority into the saving unit is applied to the printing job, and
in the controlling, out of the printing jobs saved in the saving unit, the printing job to which a low priority is applied is deleted so as not to be continuously saved with a higher priority than the printing job to which a high priority is applied.

4. The image processing apparatus according to claim 3, wherein
in the controlling, in a case where the free space of the saving unit is smaller than the prescribed value and the printing job to which the high priority is applied is not saved in the saving unit, out of the printing jobs to which the low priority is applied, the printing job that is determined according to an elapsed time since a date and time as a starting point is deleted.

5. The image processing apparatus according to claim 4, wherein
in the controlling, the printing job with the longest elapsed time since a date and time, which is any one of a date and time at which the printing is completed, a date and time at which the printing job is created, and a date and time at which the printing job is inputted, is deleted.

6. The image processing apparatus according to claim 3, wherein
in the controlling, in a case where the free space of the saving unit is smaller than the prescribed value and the printing job to which the low priority is applied and the printing job to which the high priority is applied are saved in the saving unit, out of candidates of deletion target including the printing job to which the high priority is applied and that is after an elapse of a predetermined period since printing completion and the printing job to which the low priority is applied, the printing job that is determined according to an elapsed time since a date and time as a starting point is deleted.

7. The image processing apparatus according to claim 6, wherein
in the controlling, out of the candidates of deletion target, the printing job with the longest elapsed time since a date and time, which is any one of a date and time at which the printing is completed, a date and time at which the printing job is created, and a date and time at which the printing job is inputted, is deleted.

8. The image processing apparatus according to claim 3, wherein
in the controlling, in a case where the free space of the saving unit is smaller than the prescribed value and the printing job to which the low priority is applied is not saved in the saving unit, out of the printing jobs to which the high priority is applied, the printing job that is determined according to an elapsed time since a date and time as a starting point is deleted.

9. The image processing apparatus according to claim 8, wherein
in the controlling, the printing job with the longest elapsed time since a date and time, which is any one of a date and time at which the printing is completed, a date and time at which the printing job is created, and a date and time at which the printing job is inputted, is deleted.

10. The image processing apparatus according to claim 3, wherein
in the applying, the high priority is applied to the printing job that performs inspection of the printed product, and the low priority is applied to the printing job that does not perform the inspection of the printed product.

11. The image processing apparatus according to claim 3, wherein
in the controlling, an initial value of the priority is determined based on setting of saving the printing job into the saving unit.

12. The image processing apparatus according to claim 1, wherein
in the controlling, the control is performed such that, out of the printing jobs saved in the saving unit, the printing job that performs inspection of the printed product with reference to reference image data generated from the printing job is continuously saved with a higher priority than the printing job that does not perform the inspection of the printed product.

13. The image processing apparatus according to claim 12, wherein
in the controlling, the control is performed such that the printing job that does not save the reference image data is continuously saved with a higher priority than the printing job that saves the reference image data.

14. The image processing apparatus according to claim 12, wherein
in the controlling, the control is performed such that the printing job that includes an instruction to create a report regarding the inspection is continuously saved with a higher priority than the printing job that does not include the instruction to create the report.

15. The image processing apparatus according to claim 12, wherein
in the controlling, the control is performed such that the printing job with a higher inspection level in a case of performing the inspection is continuously saved as a priority.

16. The image processing apparatus according to claim 1, wherein
reference image data that is obtained by reading a printed product that corresponds to the printing job saved in the saving unit and has no defect is saved into the saving unit in association with the printing job, and
in the controlling, in a case where a free space of the saving unit is smaller than a prescribed value, out of the printing jobs and the reference image data saved in the saving unit, the printing job that is determined based on the information and the reference image data associated with the printing job are deleted.

17. The image processing apparatus according to claim 1, wherein
in the controlling, the control is performed such that the printing job that outputs the printed product partially different for each unit of printing is continuously saved with a higher priority than the printing job that does not output the printed product partially different for each unit of printing.

18. The image processing apparatus according to claim 1, wherein
in the controlling, the control is performed such that the printing job that is controlled so as to be continuously saved as a priority into the saving unit is continuously saved for a longer period of time than the printing job that is saved so as not to be continuously saved as a priority into the saving unit.

19. The image processing apparatus according to claim 1, wherein
in the controlling, the printing job that is controlled so as not to be continuously saved as a priority into the saving unit is saved in a lower accessibility state for a shorter period of time than the printing job controlled so as to be continuously saved as a priority into the saving unit.

20. A controlling method of image processing apparatus comprising:
analyzing an inputted printing job of a printed product and applying information indicating a possibility of reusing the printing job to the printing job; and
performing control such that the printing job to which the information is applied is continuously saved into a saving unit even after execution of printing by the printing job, wherein
in the controlling, out of the printing jobs saved in the saving unit, the printing job that is determined based on the information is deleted.

21. An image processing apparatus comprising:
one or more memories storing instructions; and
one or more processors executing the instructions to:
perform control such that an inputted printing job of a printed product is continuously saved into a saving unit even after execution of printing by the printing job, wherein
in the controlling, out of the printing jobs saved in the saving unit, the printing job that performs defect inspection of the printed product is continuously saved with a higher priority than the printing job that does not perform the defect inspection of the printed product.
